(19) United States
(12) Patent Application Publication
(10) Pub. No.: US 2009/0204250 A1
(43) Pub. Date: Aug. 13, 2009

(54) SYSTEM AND METHOD FOR INTEGRATING RFID SENSORS IN MANUFACTURING SYSTEM COMPRISING SINGLE USE COMPONENTS

(75) Inventors: Radislav Alexandrovich Potyrailo, Niskayuna, NY (US); Vincent Francis Pizzi, Mills, MA (US); Staffan Klensmeden, Uppsala (SE); Richard John Ferraro, Union, NJ (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/028,380

(22) Filed: Feb. 8, 2008

(51) Int. Cl. G06F 17/00; H04Q 5/22

(52) U.S. Cl. 700/109; 340/10.41

(57) ABSTRACT

The present invention provides a system and method for measuring physical, chemical and biological properties of a manufacturing system comprising embedding a plurality of RFID sensors in a plurality of corresponding single use components wherein each of the plurality of RFID sensors is configured to provide multi-parameter measurements for at least one single use component from the plurality of single use components, and each of the plurality of RFID sensors is further configured to provide simultaneous digital identification for the single use component and for its respective RFID sensor and further comprises reading the multi-parameter measurements and the digital identification for the plurality of single use components using at least one RFID writer/reader, processing the measurements using a processor, and controlling subsequent process steps by comparing the measurements of at least one parameter to a predetermined value.

### BACKGROUND

The invention relates generally to manufacturing systems comprised of single use components, and more particularly to a system and method for integrating radio frequency identification (RFID) sensors into the manufacturing system.

Single use, disposable, equipment has gained significant interest from the manufacturing community especially the biopharmaceutical industry. Single use components offer flexibility, mobility, overall process efficiency as well as reduction in cleaning and sterilization protocols, lower risk of cross-contamination, and reduced manufacturing capital cost.

Full ranges of single use, disposable technologies for biopharmaceutical production are commercially available for simple operations such as buffer storage and mixing and are rapidly expanding into complex application such as fermentation. However, the acceptance of disposable technologies is hindered by the absence of effective single use, non-invasive monitoring technologies. Monitoring of key process parameters is crucial to secure safety, process documentation, and efficacy of the produced compounds as well as to keep the process in control. In addition, monitoring of parameters at specific locations in the manufacturing process is critically important in fermentation and active biological product storage because biological compounds are very sensitive to small environmental changes.

Thus, there is a need for a technology solution that can provide non-invasive monitoring technology compatible with manufacturing systems having single use components.

### BRIEF DESCRIPTION

In a first aspect, the invention provides a manufacturing system comprising a plurality of radio-frequency identification (RFID) sensors embedded in a corresponding plurality of single use components wherein each of the plurality of RFID sensors is configured to provide multi-parameter measurements for at least one single use component and further configured to provide simultaneous digital identification for the single use component and for its respective RFID sensor. The system further comprises a RFID writer/reader and a processor in communication with the writer/reader wherein the processor is configured to control subsequent manufacturing process steps.

In a second aspect, the invention provides a method for measuring physical, chemical and biological properties in individual components and of a manufacturing system as a whole comprising embedding a plurality of RFID sensors in a plurality of corresponding single use components wherein each of the plurality of RFID sensors is configured to provide multi-parameter measurements for at least one single use component from the plurality of single use components, and each of the plurality of RFID sensors is further configured to provide simultaneous digital identification for the single use component and for its respective RFID sensor. The method further comprises writing digital data, reading the multi-parameter measurements and the digital identification for the plurality of single use components using at least one RFID writer /reader, processing the measurements using a processor, and controlling subsequent process steps by comparing the measurments of at least one parameter to a predetermined value.

In a third aspect, the invention provides a method for assembly of a plurality of single use components for a bioprocess manufacturing system which are embedded with a corresponding plurality of integrated RFID sensors, used for measuring physical, chemical and biological properties, which comprises reading the digital identification of the RFID sensors for the plurality of single use components using at least one RFID writer/reader, processing the readings using a processor, and confirming the correct assembly of the RFID sensors into a network and respective single use components into a predetermined sequence of components.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of a disposable, rapidly assembled bioprocessing plant with disposable sensors embedded into the bioprocessing components.

FIG. 2 is an illustration of a signal acquisition from a RFID sensor to a writer/reader system.

FIG. 3 is an illustration of an exemplary RFID sensor.

FIG. 4 is flow chart of a method of monitoring a manufacturing system.

FIG. 5 is an illustration of a RFID sensor network for multivariate statistical process control.

FIG. 6 is a flow chart showing application of an RFID sensor network for multivariate statistical process control.

FIG. 7 shows the responses of four RFID temperature sensors measured through a designed and built system with a multichannel electronic signal multiplexer that operated with the network analyzer for measurements with multiple RFID sensors at once. Numbers in A-D are temperatures in degrees Celsius.

FIG. 8 shows a computer screen shot of a RFID read out.

### DETAILED DESCRIPTION

The embodiments disclosed herein facilitate monitoring and controlling the process of manufacturing systems comprising single use components by incorporating novel non-invasive RFID monitoring technologies into the single use components.

As used herein “RFID tag” refers to a data collection technology that uses electronic tags for storing data and which contains at least two components. The first component is an integrated circuit (memory chip) for storing and processing information and modulating and demodulating a radio frequency signal. This memory chip can also be used for other specialized functions, for example it can contain a capacitor. It can also contain an input for an analog signal. The second component is an antenna for receiving and transmitting the radio frequency signal. The antenna also performs sensing functions by changing its impedance parameters as a function of environmental changes.

As used herein “sensing materials and sensing films” refers to materials deposited onto the RFID sensor and perform the function of predictably and reproducibly affecting the complex impedance sensor response upon interaction with the environment. For example, a conducting polymer such as polyaniline changes its conductivity upon exposure to solutions of different pH. When such a polyaniline film is deposited onto the RFID sensor, the complex impedance sensor response changes as a function of pH. Thus, such RFID sensor works as a pH sensor. In general, a typical sensor film is a polymer, organic, inorganic, biological, composite, or nano-composite film that changes its electrical and or dielectric property based on the environment that it is placed in. Nonlimiting additional examples of sensor films may be a hydrogel such as (poly-(2-hydroxyethy)methacrylate, a sulfonated polymer such as Nafion, an adhesive polymer such as silicone adhesive, an inorganic film such as sol-gel film, a composite film such as carbon black-polyisobutylene film, a nanocomposite film such as carbon nanotube-Nafion film, gold nanoparticle-hydrogel film, metal nanoparticle-hydrogel film, electrospun polymer nanofibers, electrospun inorganic nanofibers, electrospun composite nanofibers, and any other sensor material. In order to prevent the material in the sensor film from leaking into the liquid environment, the sensor materials are attached to the sensor surface using the standard techniques, such as covalent bonding, electrostatic bonding and other standard techniques known to those of ordinary skill in the art.

The term “protecting material” is used to refer to material on the RFID sensor that protects the sensor from an unintended mechanical, physical or chemical effect while still permitting the anticipated measurements to be performed. For example, an anticipated measurement may include solution conductivity a measurement wherein a protecting film separates the sensor from the liquid solution yet allows an electromagnetic field to penetrate into solution. An example of a protecting material is a paper film that is applied on top of the sensor to protect the sensor from mechanical damage and abrasion. Another example of a protecting material is a polymer film that is applied on top of the sensor to protect the sensor from corrosion when placed in a liquid for measurements. A protecting material may also be a polymer film that is applied on top of the sensor for protection from shortening of the sensor's antenna circuit when placed in a conducting liquid for measurements. Nonlimiting examples of protecting films are paper and polymeric films such as polyesters, polypropylene, polyethylene, polyethers, polycarbonate, and polyethylene terepthalate.

The term “writer/reader” is used here in to refer to a combination of devices to write and read digital identification data and to read impedance of the antenna.

The term “single use component” refers to manufacturing equipment, which may be disposed of after use or reconditioned for reuse. Single use components include, but are not limited to, single-use vessels, bags, chambers, tubing, connectors, and columns.

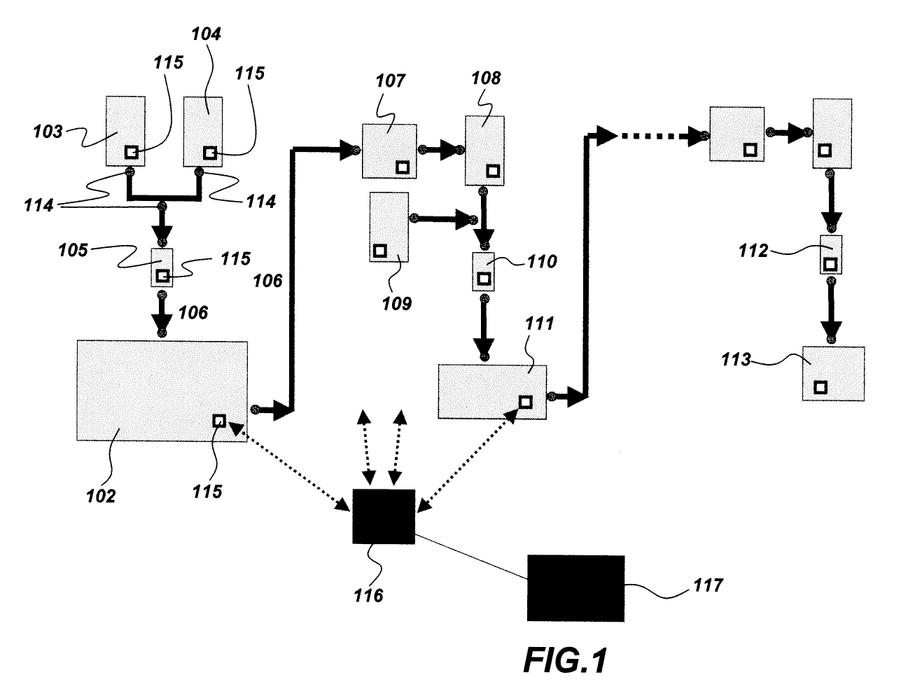

FIG. 1 illustrates one embodiment of a manufacturing system 100 that incorporates aspects of the present invention for use in bioprocessing. The system provides an attractive alternative to biopharmaceutical manufacturers as compared to conventional plants that need cleaning, sterilization, and validation between batch runs. This disposable manufacturing process has components upstream and downstream from the bioreactor. The manufacturing system may include multiple single use, and in some exemplary embodiments multiuse, components forming the disposable manufacturing system 100. In the illustrated drawing, examples of components upstream from the bioreactor 102 may include preparation bags 103, buffer/media bags 104, filters 105, and transfer lines 106. Components downstream from the bioreactor 102 may include a hollow fiber filter 107, intermediate storage containers 108, buffer containers 109, normal flow filters 110, chromatographic columns 111, filters 112, and a final product container 113. It may be noted that components 102 through 113 are non-limiting examples for single use and multiuse components.

Disposable components shown in FIG. 1 are connected through transfer lines 106 and connectors 114. Connectors 114 are shown only in the initial disposable components in FIG. 1, but maybe employed in other components throughout the manufacturing process. Disposable components in FIG.1 have integrated disposable RFID sensors 115, where in-situ measurements may be desired along the workflow of the system. The writer/reader 116 interrogates these sensors.

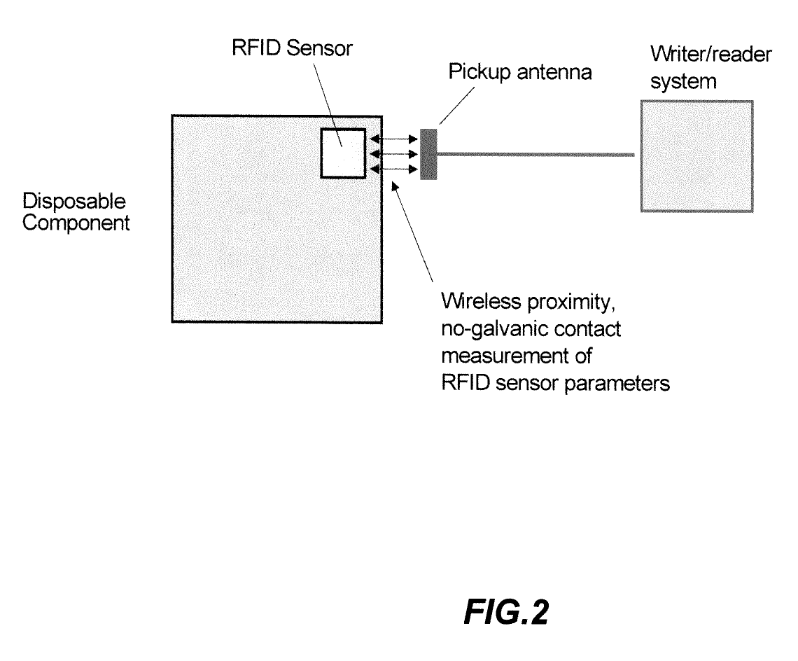

This is shown in more detail in FIG. 2, which depicts a schematic of the signal acquisition from an RFID sensor embedded in a disposable component. The RFID sensor in the disposable component is wirelessly integrated with a pickup antenna. The pickup antenna is connected directly or through a cable to a writer/reader system.

These embedded disposable RFID sensors provide the same sensor platform for measurements of physical, chemical, and biological parameters. In other words, the multi-parameter measurements are representative of physical, chemical and biological parameters of the single use component. Referring further to FIG. 1, the RFID sensors 115 provide in situ, in-line, accurate and reliable proximity readout of key parameters during bio-pharmaceutical manufacturing. Each of the RFID sensors 115 is further configured to provide simultaneous digital identification for the single use component (e.g. its correct assembly and use, production and expiration date, etc.) and for a respective RFID sensor (e.g. its calibrations, correction coefficients, etc.). RFID sensor data is transmitted from the writer/reader 116 to a receiver or a workstation processor 117 from where the data may be accessed by plant operators or further processed. The embodiments described herein for in-line analysis significantly contribute to dramatically more efficient fermentation control in the bioprocessing system shown in FIG. 1. The key operations of other single use components include mixing, product transfer, connection, disconnection, filtration, chromatography, distillation, centrifugation, storage, and filling. For these diverse needs, disposable RFID sensors described herein enable the in-line monitoring and control of the multi-parameters. Some non-limiting examples of the environmental parameters measured by the RFID sensors include solution conductivity, pH, temperature, pressure, flow, dissolved gases, metabolic products (glucose, lactate, etc.) concentration, cell viability, and level of contaminants. It may also be beneficial in some embodiments for the RFID sensors to be gamma radiation resistant. Gamma radiation may be used for gamma sterilization of the components.

A continuous measurement of physical, chemical, and physiological data using the embodiments described herein facilitates a designated feeding strategy for nutrients, resulting in a more robust process performance with a high probability to enhance the cell productivity. In contrast, the sensors that are currently widely used for in-line measurements are invasive and break the sterility barrier. Some more sophisticated measurements related to fermentors (amines, glucose content) are currently performed off-line reducing the efficiency of the process, compromising sterility, and limiting manufacturing portability. The disposable nature of sensor embodiments described herein provides an intact sterility barrier, and attractively eliminates cleaning and re-use.

Furthermore the RFID sensors described herein may prevent the incorrect assembly of a single use network. In conventional stainless steel systems the use of male/female connections prevent the incorrect interconnection of piping from one point to another in the system. In the single use environment, thermoplastic tubing is quite often used to weld two or more components such as a bioreactor to a hollow fiber filter. So it is quite possible that the operator could make an incorrect connection and assembly. For example a media filter could be connected to a bioreactor when in fact the desired filter was a hollow fiber. With an RFID network the end user can specify in advance the correct order of components assembly. During assembly, an operator could scan key components, such as the bioreactor, and the writer/reader could be configured to indicate or confirm the next component to be added to the process chain.

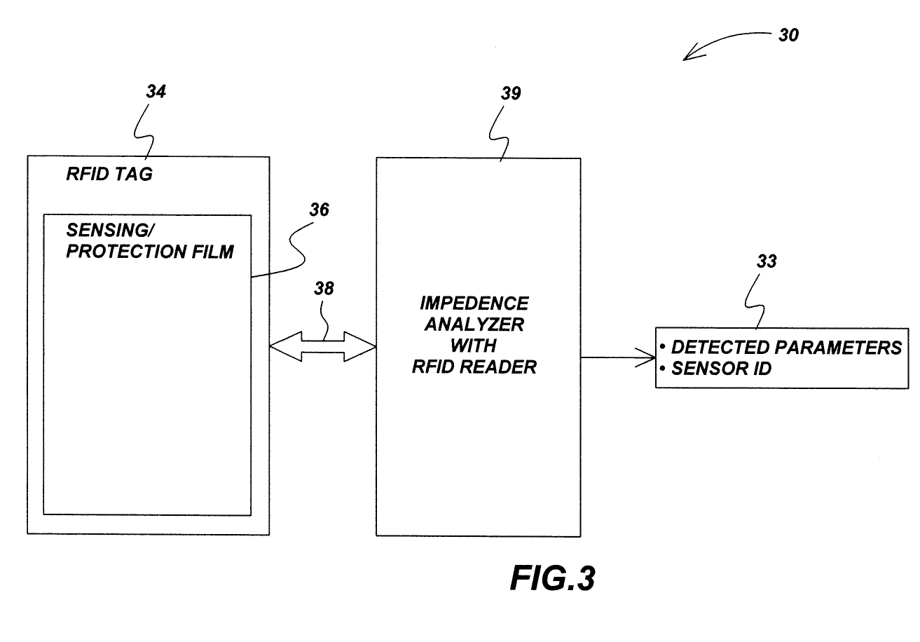

An exemplary RFID sensor 30 is shown in more detail in FIG. 3. The RFID sensor described herein includes an RFID component or RFID tag 34, a sensing or protecting film 36 that includes a sensor coating that is developed for adequate chemical or biological recognition, and optionally a protective layer to avoid the corrosion and/or electrical shortening of the bioprocessing fluids to RFID electronic components. Deposition of sensor materials developed onto RFID may be performed using arraying, ink-jet printing, screen printing, vapor deposition, spraying, draw coating, or other identified and validated deposition methods. Exemplary RFID sensors have been described in US patent applications titled “Chemical and biological sensors, systems and methods based on radio frequency identification” Ser. No. 11/259710 and “Chemical and biological sensors, systems and methods based on radio frequency identification” Ser. No. 11/259711 incorporated herein by reference. The sensor 30 may further include an impedance analyzer as part of the RFID writer/reader 39. The data line 38 indicates that there is data transferred between the RFID tag 34, the sensing and protection layer 36 and the impedance analyzer with the RFID writer/reader 39. For example the data from the RFID tag 34 and sensing and protection film 36 may include the impedance detected and the ID (identification) detected for a specific disposable component. Similarly the data from the impedance analyzer and RFID writer/reader 39 may include energy components and clock values. Finally block 33 represents the output of the RFID sensor that includes the detected parameters and sensor ID as described earlier.

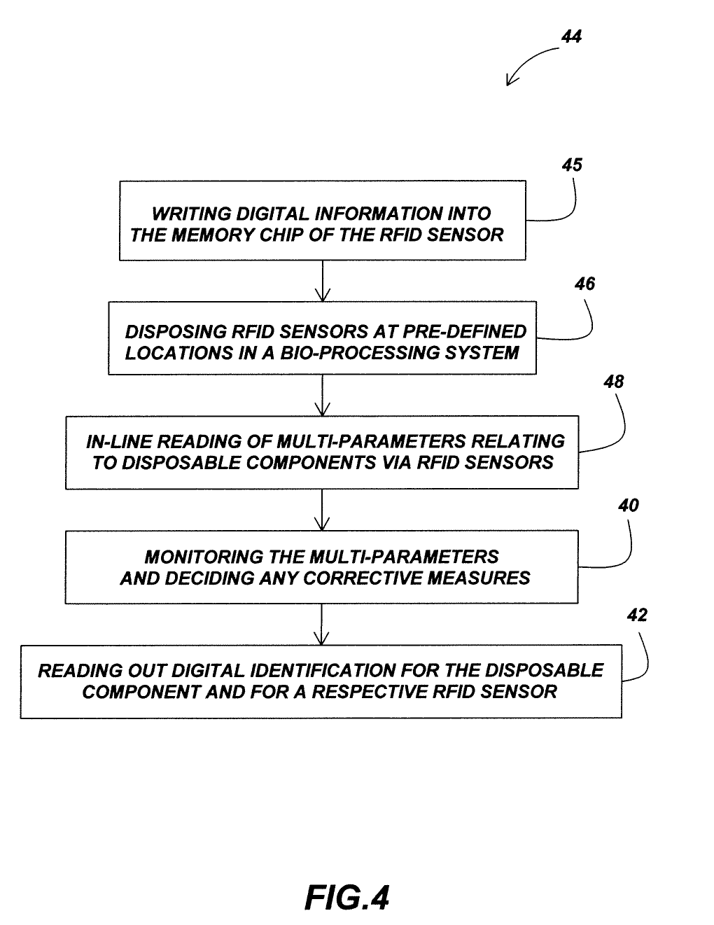

Another embodiment of the invention is a method of monitoring a manufacturing system as shown in flowchart 44 in FIG. 4. The method includes step 45 for writing digital information into the memory chip of the RFID sensor and step 46 for disposing RFID sensors at pre-defined locations in a manufacturing system. The method further includes a step 48 for in-line reading of multi-parameters relating to single use components of the manufacturing system, via the plurality of RFID sensors. The method may further include a step 40 for monitoring the multi-parameters and deciding any corrective measures based on monitored data. The multi-parameters described herein include physical, chemical and biological parameters of the single use component. The method further includes a step 42 for reading out digital identification for the single use component and for a respective RFID sensor. The digital identification includes information regarding assembly and use, production and expiration for the single use component and information regarding calibration, and correction coefficients for the respective sensor.

In one embodiment of the invention, before operation of the manufacturing system, digital information is first written into the memory chip of each RFID sensor with respect to production history of the sensor and single use component. The data includes, but is not limited to production date, lot identification, gamma radiation dose received, and calibration parameters of the sensor. Second, before operation of the manufacturing system, digital information is written into the memory chip of each RFID sensor that contains identifiers of the required adjoining single use components during assembly. This information is read during the assembly process to confirm the correct assembly of the system. Third, before operation of the manufacturing system, digital information is read from the memory chip of each RFID sensor corresponding to the calibration parameters of the sensor. The calibration parameters are stored directly in the memory of the chip. Other embodiments may have an additional step wherein, during operation of the manufacturing system, digital information is written into the memory chip of each RFID sensor related to abnormalities of the sensor and the associated single use component, and other process conditions that require documentation.

Typically, process variables such as flow, pressures, concentrations, and temperature are subject to statistical process control (SPC) strategies. SPC statistical methods focus on a single process variable at a time, using univariate controls such as: Shewhart charts, cumulative sum charts, and exponentially weighted moving average charts. These charts are used to monitor the performance of a single process over time to verify that the process consistently operates within the specifications of the manufactured product. This allows for automatic or manual control of subsequent steps in the manufacturing process such as, but not limited to, initiation, termination or changes to operating parameters. With the increase in the number of monitored process variables affecting the process behavior however, the univariate SPC analysis methods may become inadequate in revealing interactions between multiple process variables. In addition, application of univariate techniques can result in misleading information being presented to the process operator and can lead to unnecessary or erroneous control actions.

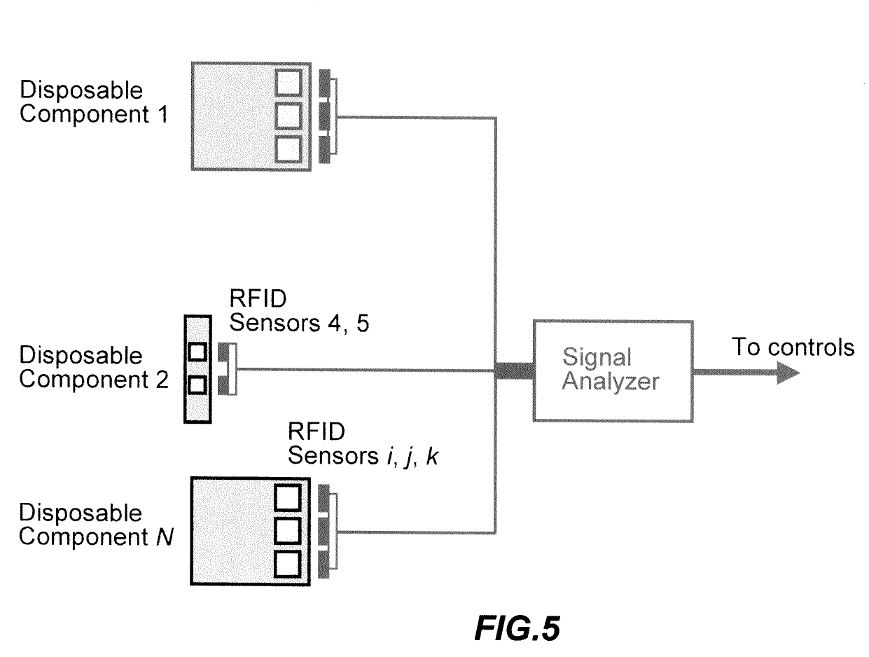

An attractive alternative approach is to employ multivariate methods to extract more relevant information from the measured data that is unavailable using conventional univariate tools. Thus, another embodiment of the invention uses a sensor network for multivariate statistical process control. This is illustrated in FIG. 5 where a plurality of sensors (1,2,3 . . . i,j,k) are arranged in single use components (1c, 2c . . . Nc) for acquisition of dynamic data from multiple locations along the process. The signal analyzer allows for the transfer of data to a control system.

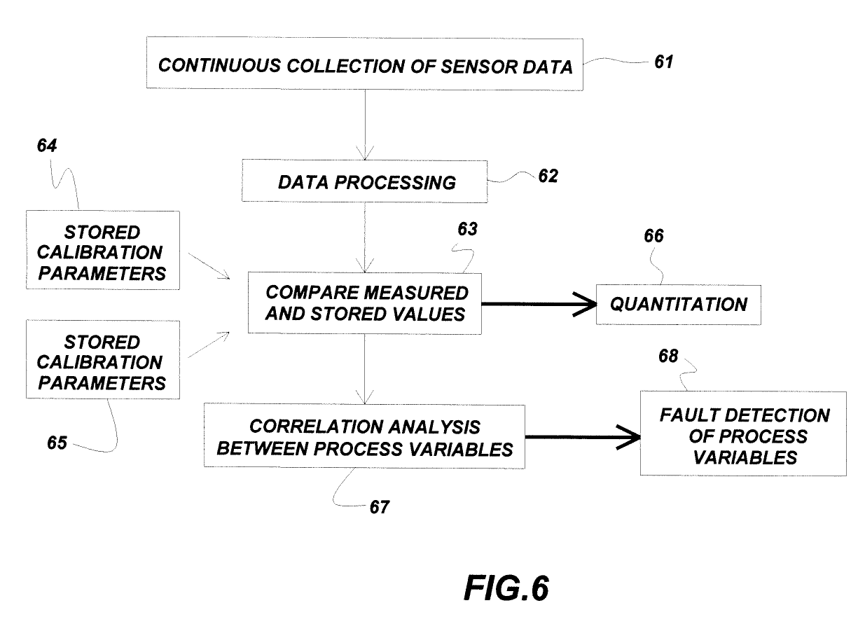

Application of multivariate statistical methods to industrial process data characterized by a large number of correlated process measurements is the area of process chemometrics and provides for engineering process control of the manufacturing system. The method is illustrated in FIG. 6 and includes the continuous collection of sensor data 61, which is processed 62, and compared 63, to measured and stored values previously written to the memory chip 64 and 65. The stored data is compared to the continuous sensor data providing quantitation of measured values 66. Correlation analysis between the process variables 67 provides a fault detection of the individual variables 68.

Several statistical tools, such as multivariate control charts and multivariate contribution plots is used in the correlation analysis between process variables 67. Multivariate control charts use two statistical indicators of the principal components analysis (PCA) model such as Q and T2 values. The significant principal components of the PCA model are used to develop the T2-chart and the remaining principal components (PCs) contribute to the Q-chart. The Q residual is the squared prediction error and describes how well the PCA model fits each sample. It is a measure of the amount of variation in each sample not captured by K principal components retained in the model

Qᵢ=eᵢeᵢ^{T}=xᵢ(I−PₖPₖ^{T})xᵢ^{T}

where eᵢ is the ith row of E, xᵢ is the ith sample in X, Pₖ is the matrix of the k loadings vectors retained in the PCA model (where each vector is a column of Pₖ) and I is the identity matrix of appropriate size (n×n). The Q residual chart monitors the deviation from the PCA model for each sample.

The sum of normalized squared scores, known as Hotelling's T2 statistic, gives a measure of variation within the PCA model and determines statistically anomalous samples. T2 is defined as:

T²ᵢ=tᵢλ⁻¹tᵢ^{T}=xᵢPλ⁻¹P^{T}xᵢ^{T}

where tᵢ is the ith row of Tₖ, the matrix of k scores vectors from the PCA model and λ⁻¹ is the diagonal matrix containing the inverse of the eigenvalues associated with the k eigenvectors (principal components) retained in the model. The T2 chart monitors the multivariate distance of a new sample from the target value in the reduced PCA space. The multivariate Q and T2 control charts plotted as a function of process time are statistical indicators in multivariate statistical process control of biomanufacturing.

In certain embodiments the RFID network and the univariate or multivariate SPC provide a method to adjust parameters at various points within the disposable network. For example, in a current bioprocess such as E Coli fermentation, the cells produce proteins that are later purified. Under some manufacturing conditions proteins will not fold into their biochemically functional forms. High concentrations of solutes, extremes of pH or temperature at certain stages of the cell production process in the bioreactor can cause proteins to unfold or denature. These denatured proteins make downstream purification more difficult and result in low yields. Typically fermentation and purification are batch processes therefore it is not until the later purification process that low yield is discovered. With an integrated RFID network, sensors could detect shifts in temperature, pH and other key parameters and with process control change operating conditions in the bioreactor in real time. In yet another embodiment a continuous, rather than batch process, maybe used where RFID sensors, detecting key parameters downstream, adjust conditions in the reactor upstream to increase yield of the desired protein.

### EXAMPLE 1

An RFID sensor network has been developed to collect information from multiple RFID sensors with a single data collection device. In one example, temperature sensing has been performed with four RFID temperature sensors. The sensors and their associated pick up antennas were positioned into an environmental chamber where temperature was changed in a controlled fashion from 0 to 120° C. in 20° C. increments.

Measurements of the complex impedance of RFID sensors were performed with a network analyzer (Model E5062A, Agilent Technologies, Inc. Santa Clara, Calif.) under computer control using LabVIEW. The network analyzer was used to scan the frequencies over the range of interest and to collect the complex impedance response from the RFID sensors. A multichannel electronic signal multiplexer was built to operate with the network analyzer for simultaneous measurements with multiple RFID sensors.

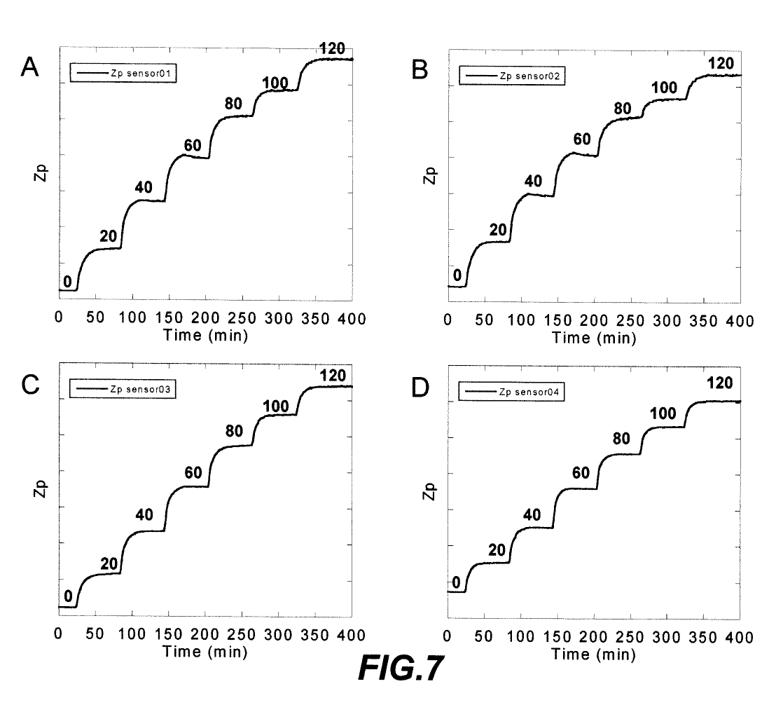

FIG. 7 demonstrates responses of four RFID temperature sensors measured through a designed and built system with a multichannel electronic signal multiplexer that operated with the network analyzer for measurements with multiple RFID sensors at once.

### EXAMPLE 2

An RFID sensor system was developed to collect (1) complex impedance signal from the resonant antenna circuit of the RFID sensor and (2) digital information from the memory chip of the RFID sensor. Measurements of the complex impedance of RFID sensors were performed with a network analyzer (Model E5062A, Agilent Technologies, Inc. Santa Clara, Calif.) under computer control using LabVIEW. The network analyzer was used to scan the frequencies over the range of interest and to collect the complex impedance response from the RFID sensors. A multichannel electronic signal multiplexer was built to operate with the network analyzer for measurements with multiple RFID sensors at once. Digital ID readings from the memory microchips of RFID sensors were performed using a SkyeTek computer-controlled (using LabVIEW) writer/reader, respectively (Model M-1, SkyeTek, Westminster, Colo.). Other RFID writer/readers are available, such as a hand held SkyeTek writer/reader and a computer-controlled multi-standard RFID writer/reader evaluation module (Model TRF7960 Evaluation Module, Texas Instruments).

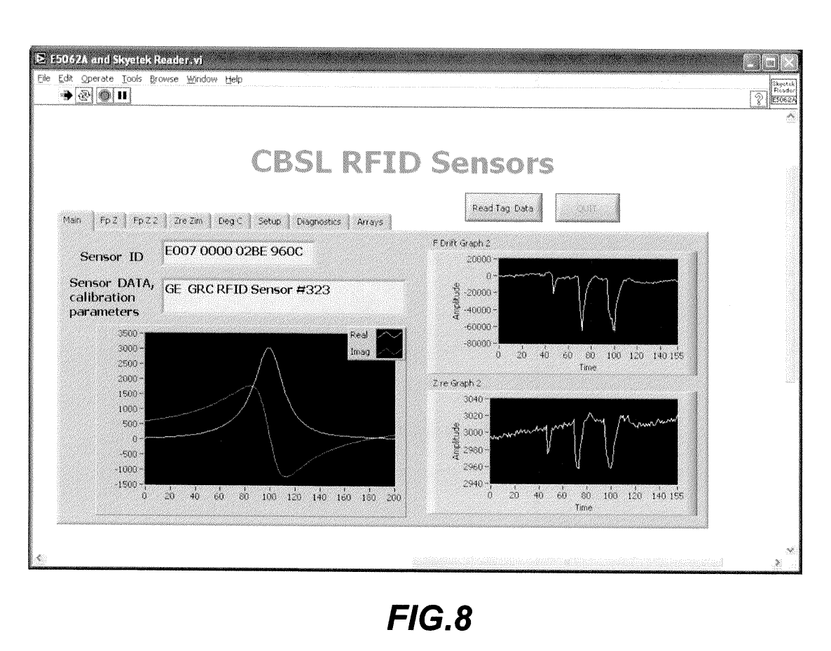

For validation of the approach, a Texas Instruments RFID tag was used. The tag was coated with a polyaniline sensing film to produce a pH sensor. The digital ID of the tag was read with the writer/reader as defined above to be E007 000 02BE 960C. Subsequently, the writer/reader was used to write additional digital data into the memory chip. In one example, the written data was GE GRC RFID Sensor #323; in another example the written data was A0=0.256; A1=33.89; A2=0.00421; A3=0.0115. The writer/reader was further used in the reading mode to read digital portion from the sensor and analog portion (complex impedance) as shown in FIG. 8. Other RFID tags and writer/readers could be employed.

It may be noted that the method and system described herein is not limited to pharmaceutical manufacturing, but could be easily extended to other manufacturing areas that will focus on point of use contamination detection, monitoring product storage containers in transit combined with unique identification tags, and others. Manufacturing systems include those systems used to produce commercial products but also may include smaller scale developmental processes and laboratory scale processes. In addition, the other applications of disposable RFID sensors described herein for disposable manufacturing can be further employed for detection of pathogenic and other species in packaged foods, self-reporting sample collectors of environmental and industrial water, and for other demanding military and civil applications where the strong unmet need exists for disposable sensors.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A manufacturing system comprising:
a plurality of radio-frequency identification (RFID) sensors embedded in a corresponding plurality of single use components wherein each of the plurality of RFID sensors is configured to provide multi-parameter measurements for at least one single use component from the plurality of single use components, and each of the plurality of RFID sensors is further configured to provide simultaneous digital identification for the single use component and for its respective RFID sensor;
at least one RFID writer/reader configured to read at least one RFID sensor; and
a processor in communication with the at least one RFID writer/reader wherein the RFID writer/reader is configured to communicate data to the processor for comparing to at least one parameter to a predetermined value, and wherein the processor is further configured to control subsequent process steps.

2. The system of claim 1 wherein the RFID sensor is comprised of a RFID memory chip , an antenna, and is coated with a sensing or protecting material.

3. The system of claim 1, wherein the multi-parameter measurements are representative of physical, chemical and biological parameters of the single use component and wherein the simultaneous digital identification comprises at least one of the following; information regarding part identification, assembly, use, correction coefficients, calibration, production history, shelf life, and expiration date for the single use component.

4. The system of claim 1 wherein the plurality of RFID sensors form a sensor network for statistical process control.

5. The system of claim 4 wherein the statistical process controls comprises univariate statistical process control or multivariate statistical process control.

6. The system of claim 4 wherein the statistical process controls is used to determine one or more subsequent process steps.

7. The system of claim 6 wherein the subsequent process steps comprises initiation, termination, or changes in operating parameters.

8. The system of claim 7 wherein the subsequent process steps are automated or performed by an operator.

9. The system of claim 1 further comprising a sensor network for engineering process controls.

10. The system of claim 9 wherein the engineering process controls comprises modeling of the system and using control theory to determine processing paramaters.

11. The system of claim 1 wherein the manufacturing system is biological.

12. The system of claim 1 wherein the system is functionally adapted for use in a bioburden controlled or sterile environment.

13. A method for measuring physical, chemical or biological properties of a manufacturing system comprising:
embedding a plurality of radio-frequency identification (RFID) sensors in a plurality of corresponding single use components wherein each of the plurality of RFID sensors is configured to provide multi-parameter measurements for at least one single use component from the plurality of single use components, and each of the plurality of RFID sensors is further configured to provide simultaneous digital identification for the single use component and for its respective RFID sensor;
reading the multi-parameter measurements and the digital identification for the plurality of single use components using at least one RFID writer/reader;
processing the measurements using a processor; and
controling subsequent process steps by comparing the measurments of at least one paramter to a predetermined value.

14. The method of claim 13 wherein the RFID sensor is comprised of a RFID tag, an antenna, and is coated with a sensing and protecting material.

15. The method of claim 13, wherein the multi-parameter measurements are representative of physical, chemical or biological parameters of the single use component and wherein the simultaneous digital identification comprises at least one of the following; information regarding part identification, assembly, use, correction coefficients, calibration, production history, shelf life, and expiration date for the single use component.

16. The method of claim 13 wherein the plurality of RFID sensors form a sensor network for statistical process control.

17. The method of claim 16 wherein the statistical process controls comprises univariate statistical process control or multivariate statistical process control.

18. The method of claim 17 wherein the statistical process control is used to determine one or more subsequent process steps.

19. The method of claim 13 wherein the subsequent process steps comprises initiation, termination, or changes in operating parameters.

20. The method of claim 19 wherein the subsequent process steps are automated or performed by an operator.

21. The method of claim 13 further comprising a sensor network for engineering process controls.

22. The method of claim 21 wherein the engineering process controls comprises modeling of the system and using control theory to determine processing paramaters.

23. The method of claim 13 wherein the manufacturing system is biological.

24. The method of claim 13 wherein the system is functionally adapted for use in a bioburden controlled or sterile environment.

25. A method for assembly of a plurality of single use components for a bioprocess manufacturing system with integrated RFID sensors in single use components measuring physical, chemical or biological properties of a bioprocess manufacturing system comprising:
embedding a plurality of RFID sensors in a corresponding plurality of single use components wherein each of the plurality of RFID sensors is configured to provide multi-parameter measurements for at least one single use component from the plurality of single use components, and each of the plurality of RFID sensors is further configured to provide simultaneous digital identification for the single use component and for its respective RFID sensor;
reading the digital identification of at least one RFID sensors for the plurality of single use components using at least one RFID writer/reader;
processing the readings using a processor; and
confirming the correct assembly of the RFID sensor network.
